(19) United States
(12) Patent Application Publication
(10) Pub. No.: US 2005/0224243 A1
(43) Pub. Date: Oct. 13, 2005

(54) Tool holding fixture for a machine tool

(76) Inventors: Otto Baumann, Leinfelden-Echterdingen (DE); Rolf Mueller, Leinfelden-Echterdingen (DE); Dietmar Saur, Gomaringen (DE); Helmut Heinzelmann, Stuttgart (DE); Thomas Bernhardt, Aichtal-Groetzingen (DE); Hardy Schmid, Stuttgart (DE)

Correspondence Address: Striker Striker & Stenby, 103 East Neck Road, Huntington, NY, 11743, US

(21) Appl. No.: 10/513,934

(22) PCT Filed: Jun. 27, 2003
(86) PCT No.: PCT/DE03/02142

§ 371 Date: Nov. 10, 2004

(30) Foreign Application Priority Data
Jul. 10, 2002 (DE) 102309914

(51) Int. Cl. B25D 9/00

(52) U.S. Cl. 173/128; 173/201

(57) ABSTRACT

The invention relates to a tool receptacle for a hand power tool, in particular for a drill hammer, having a receiving opening (12) for receiving a tool shaft (14) and having a hammering bolt (16), and the tool shaft (14) and/or the hammering bolt (16) has a ready position located between an idling position and a hammering position, and having a lubricant opening (56) for delivering lubricant, which lubricant opening is fixed relative to the hammering bolt (16), and having a lubricant valve (16, 56) with a variable valve position for metering lubricant. It is proposed that the valve position of the lubricant valve (16, 56) be dependent on the ready position of the hammering bolt (16) and/or of the tool shaft (14), between the idling position and the hammering position.

The invention is based on a tool receptacle for a hand power tool as generically defined by the preamble to claim 1.

From German Patent Disclosure DE 198 05 187 A1, a drill hammer is known with this kind of tool receptacle, which has a cylindrical receiving opening for receiving a tool shaft. The tool shaft is locked in the receiving opening by a locking element. In operation, an axially oscillating hammering bolt strikes blows on the tool shaft. The locking therefore makes an axial play of the tool possible, so that the tool can escape the blows of the hammering bolt and can transmit the blows to the machined workpiece.

In operation of the drill hammer and/or jackhammer, both the tool shaft and the receiving opening are subject to considerable mechanical stresses, so that compulsory lubrication is provided in order to reduce wear. To that end, a lubricant opening is made in the wall of the receiving opening and is supplied with lubricant from a lubricant container. A ball valve is disposed in the lubricant opening and upon insertion of the tool is opened by the tool shaft, causing lubricant to enter the receiving opening. During operation, conversely, the ball valve closes the lubricant opening, so that no lubrication occurs.

From DE 198 05 187 A1, it is also known to use other types of valve instead of the ball valve, such as a temperature-dependent valve or a valve actuated by centrifugal force, in order to bring about lubrication as needed.

Finally, DE 198 05 187 A1 also discloses a tool receptacle with compulsory lubrication in which the hammering bolt, on its face end, has a spring-loaded lubricant valve which opens each time the tool shaft is struck, causing lubricant to be fed into the receiving opening. Hence the lubricant delivery is located partly in the hammering bolt and as a result is exposed to severe jarring.

### ADVANTAGES OF THE INVENTION

The invention encompasses the general teaching, in a tool receptacle with a movable hammering bolt (header) and a lubricant opening that is fixed relative to the hammering bolt, of metering the lubricant as a function of the ready position of the hammering bolt and/or of the tool shaft, to achieve compulsory lubrication during operation.

The term “fixed lubricant opening” used in the context of this invention should be understood in a general sense and serves to distinguish over the known compulsory lubrication described at the outset, in which the lubricant opening is disposed in the face end of the movable hammering bolt, causing the lubricant delivery to be exposed to considerable jarring during operation.

The lubricant metering is effected here preferably by uncovering or blocking off the lubricant opening by means of a lubricant valve; the uncovering and blocking are effected as a function of the ready position of the tool shaft, or as a function of the ready position of the hammering bolt.

The term “operating position” of the tool shaft or hammering bolt used in the context of the invention should also be understood generally and serves solely to distinguish from the aforementioned known tool receptacle in which the tool shaft opens the lubricant valve only upon insertion into the receiving opening, while conversely no lubrication takes place during normal operation.

In a preferred embodiment, the lubricant metering is effected as a function of the ready position of the hammering bolt, and the hammering bolt is displaceable in operation between an idling position and an operating position.

In this embodiment, the lubricant opening is preferably opened when the hammering bolt is in the idling position, while conversely the lubricant opening is preferably closed when the hammering bolt is in the hammering position. In this way, each time the tool set down from the workpiece, lubricant is delivered.

However, it is alternatively also possible for the lubricant opening to be open when the hammering bolt is in the ready position, while the lubricant opening is conversely closed when the hammering bolt is in the idling position. In this way, the lubricant delivery is interrupted each time the tool is set down from the workpiece.

Furthermore, it is possible to provided a plurality of lubricant openings, which are triggered in different ways by the hammering bolt. For instance, one lubricant opening can be open in the idling position of the hammering bolt and closed in the hammering position of the hammering bolt, while conversely another lubricant opening is closed in the idling position and is open in the hammering position. One lubricant opening accordingly brings about lubrication during idling, while the other lubricant opening offers lubrication during hammering operation.

The lubricant opening for idling lubrication is preferably larger than the lubricant opening for the lubrication during the hammering operation. In hammering operation, accordingly, only a slight amount of lubricant is metered, while conversely in idling, after the tool is set down from the machined workpiece, a greater amount of lubricant is metered.

In a preferred embodiment of the invention, the uncovering and blocking of the lubricant opening is effected by the hammering bolt, so that the hammering bolt and the lubricant opening together form a lubricant valve. The hammering bolt is displaceable in a guide sleeve, and the lubricant opening is disposed in the guide sleeve. The hammering bolt thus preferably forms a piston that is axially displaceably supported in the guide sleeve and that blocks and uncovers the lubricant opening.

In a preferred embodiment of the invention, the hammering bolt has three portions, which border one another axially. The middle portion serves to control the lubricant valve, so that the outer diameter of the hammering bolt in the middle portion is substantially equal to the inner diameter of the guide sleeve. The two outer portions conversely serve to receive a blow from the beater, or for transmitting a blow onward to the tool shaft. The outer diameter of the hammering bolt is therefore preferably smaller in the two outer portions than the inner diameter of the guide sleeve. This offers the advantage that in the two outer portions of the hammering bolt, an annular gap between the jacket face of the hammering bolt and the guide sleeve remains open and lubricant can flow through it.

The lubricant can selectively pass through the lubricant opening disposed in the guide sleeve either from the inside outward, or from the outside inward.

Preferably, however, the lubricant is delivered inside the guide sleeve, while the lubricant opening disposed in the guide sleeve merges on the outside with a lubricant conduit that discharges into the receiving opening, so as to supply the tool shaft and the hammering bolt as applicable with lubricant.

The lubricant conduit may for instance discharge axially into the receiving opening, so that the delivered lubricant first arrives at the face end of the tool shaft that has been inserted into the receiving opening. However, it is also possible for the lubricant conduit to discharge laterally from outside into the receiving opening, so that the delivered lubricant first arrives at the jacket face of the tool shaft.

The delivery of the lubricant is preferably effected by means of an integrated lubricant container, which may for instance be disposed in the gearbox of the hand power tool. Another possible way of delivering lubricant is to provide the supply directly from the lubrication of the product. Such a disposition of the lubricant container offers the advantage on the one hand that a sufficient quantity of lubricant can be accommodated. On the other hand, this disposition of the lubricant container advantageously makes simple filling possible by means of a T-handle bore in the gearbox.

The lubricant container is preferably in communication with the interior of the guide sleeve through a lubricant conduit.

In a preferred embodiment, the hammering bolt has at least one sealing element on its inside, for reliably sealing off the lubricant opening. It is especially advantageous if on its outside the hammering bolt has at least two sealing elements, which are axially offset from one another such that the lubricant opening disposed in the guide sleeve is located axially between the two sealing elements, in an operating position of the hammering bolt. Thus the two sealing elements can seal off the lubricant opening axially on both sides.

In the above-described embodiment, a hammering position is effected as a rule only in the idling position, when the hand power tool has been set down from the workpiece and the hammering bolt has assumed its idling position. During the hammering mode, conversely, there is as a rule no lubricant delivery, since the hammering bolt is then in its hammering position.

Conversely, in a variant of the invention, it is provided that lubricant delivery is effected even during the hammering operation, when the hammering bolt is in the hammering position. The lubricant metering is effected through the guide sleeve of the hammering bolt; the guide sleeve is axially displaceable by the hammering bolt and uncovers the lubricant opening in an axial position. In this variant of the invention, advantageous use is made of the fact that the hammering bolt, after imparting its impetus to the tool shaft, experiences an oppositely oriented B impact from the tool shaft. The impetus of this B impact is transmitted by the hammering bolt to the guide sleeve, which thereupon displaces axially and in the process uncovers the lubricant opening. In this variant of the invention, there is lubricant delivery as a rule upon every blow, so that even in a long-lasting hammering operation with brief pauses, adequate lubrication is still assured.

The transmission of the B impact from the hammering bolt to the guide sleeve can be effected for instance by means of a shoulder mounted on the guide sleeve of the tool and preferably protruding inward. Upon the axial displacement of the hammering bolt in response to the B impact, the hammering bolt then strikes the shoulder of the guide sleeve and carries it along with it in the axial direction. Instead of a shoulder, other components that are secured to the guide sleeve or integrally formed onto it can attain the slaving of the guide sleeve during the B impact.

In this variant of the invention, a spring and/or damping element is preferably provided, which after the axial displacement caused by the B impact returns the guide sleeve to its outset position again, in order to close the lubricant opening. An elastic ring, which may for instance be embodied as a rubber ring, is suitable for this purpose. For instance, the elastic ring may be disposed between a radially protruding collar of the guide sleeve and counterpart bearing, so that during the B impact the elastic ring is compressed by the axial displacement of the guide sleeve. After the transmission of impetus from the hammering bolt to the guide sleeve, the elastic ring then resumes its normal shape and as a result presses the guide sleeve into its outset position.

In this variant of the invention, the lubricant opening is preferably disposed on a face end of the guide sleeve, and the guide sleeve can close the lubricant opening, preferably with one of its face ends. In its outset position, the guide sleeve is therefore located with one of its face ends against a sealing element, which may for instance be a ring. If the guide sleeve then lifts from the sealing element in response to the B impact, a gap is created between the sealing element and the guide sleeve, through which lubricant can be delivered.

For metering the lubricant, the sealing element is preferably elastic and has at least one lubricant opening, which is closed in the outset position of the guide sleeve and opens when the guide sleeve lifts from the sealing element. In this way, it is attained that during a B impact, not too much lubricant will be delivered, since it is not a complete annular gap that is uncovered but only the lubricant opening in the sealing element. The lubricant opening may for instance be a notch that is made in an O-ring used as a sealing element.

However, within the context of the invention it is not a requirement that the lubricant opening be disposed in the sealing element on which the guide sleeve rests. Instead, it is also possible for the lubricant opening to be disposed in the guide sleeve and to be uncovered or blocked by the sealing element.

It is furthermore possible for the lubricant opening to be disposed in the jacket face of the guide sleeve; the lubricant valve is then embodied as a slide valve, because the lubricant valve in the wall of the guide sleeve is sealed off or uncovered as a function of the axial position of the guide sleeve.

In the variant of the invention described above, with an axially displaceable guide sleeve, the valve position of the lubricant valve is accordingly likewise dependent on the position of the hammering bolt, since in the idling position of the hammering bolt no B impacts are transmitted to the guide sleeve, and accordingly no lubricant delivery is effected, either. However, the actual metering of the lubricant supply is effected as a function of the axial position of the guide sleeve.

The invention furthermore includes a hand power tool having the above-described tool receptacle of the invention. The tool receptacle of the invention can be used especially advantageously in a drill hammer or a chipping hammer, but the invention is not limited to these types of hand power tools.

### DRAWINGS

Further advantages will become apparent from the ensuing drawing description. In the drawings, exemplary embodiments of the invention are shown. The drawings, description and claims include numerous characteristics in combination. One skilled in the art will expediently consider the characteristics individually as well and put them together to make useful further combinations.

Shown are:

FIG. 1a, a side view in section of a tool receptacle of the invention, without an inserted tool;

FIG. 1b, the side view in section of FIG. 1a with a tool inserted;

FIG. 2, a view of the detail outlined in dashed lines in FIGS. 1a and 1b;

FIG. 3, a fragmentary view of a tool receptacle in a cross-sectional view;

FIGS. 4a, 4b, views of a detail of FIG. 3; and

FIG. 5, a sealing ring of the tool receptacle of FIG. 3.

### DESCRIPTION OF THE EXEMPLARY EMBODIMENTS

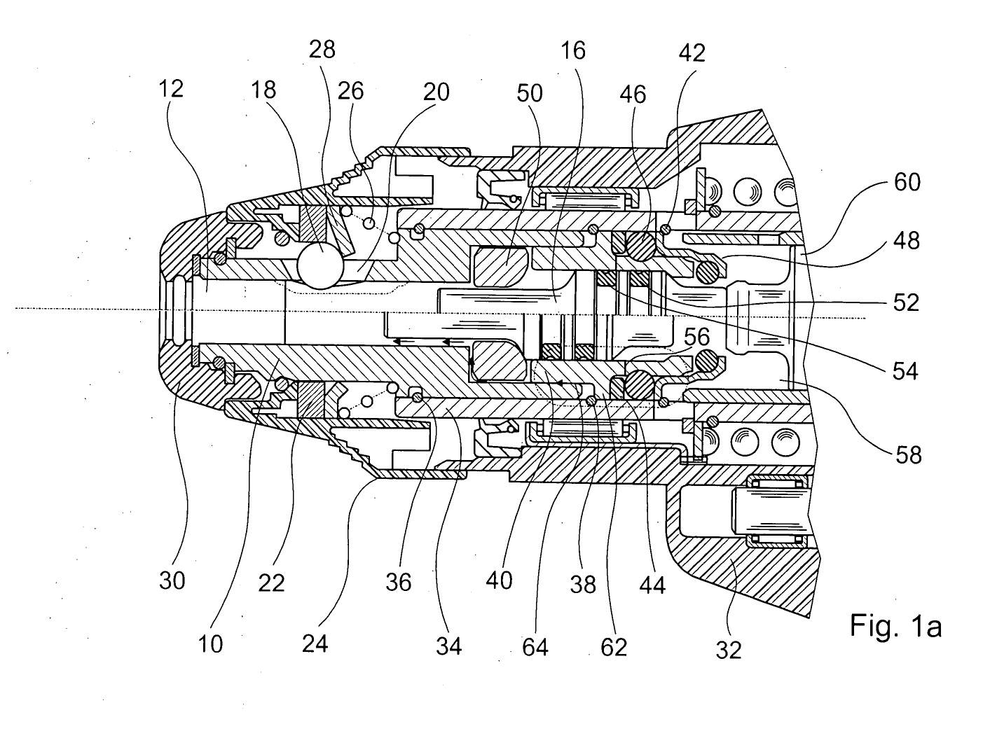

In FIGS. 1a and 1b, a tool receptacle of a drill hammer, not shown in further detail, is shown, which has a receiving body 10. The receiving body 10 forms a central receiving opening 12, into which an insertion end of a tool shaft 14 of a drill or chipper can be inserted, as is shown in FIG. 1b. Toward the tool, a hammering bolt 16 (header) protrudes into the receiving opening 12 and in the hammering mode of the drill hammer it exerts axial blows on the tool shaft 14.

The tool receptacle is provided in a known manner with a tool locking means, which in this example includes a locking element formed by a ball 18, which is disposed in an aperture 20 in the receiving body 10, and which in a locking position protrudes partway from outside into the receiving opening 12. In the process, the ball 18 is prevented from dropping all the way into the receiving opening 12 by a conically tapered embodiment of the lateral dimensions of the aperture 20. The ball 18 is covered radially by a closing ring 22, which is axially displaceable by means of an actuation sleeve 24 that fits around the receiving body 10. A spring 26 urges the closing ring 22 with an axial force in the direction of the locking position, in which the closing ring 22 radially covers the ball 18. A retaining baffle 28 is disposed between the spring 26 and the closing ring 22 and deflects axially counter to spring force upon insertion of the tool shaft 14. Hence the closing ring 22 needs to be actuated only for unlocking the tool shaft 14.

The end toward the tool of the receiving body 10 is covered in a known manner by a dust guard cap 30, which when the tool shaft 14 has been inserted rests on it and thus prevents dust from drilling from getting into the receiving opening 12.

The tool receptacle is mounted on a gearbox 32 of the drill hammer; the receiving body 10 is disposed inside a guide tube 34 of the drill hammer and forms a press fit with the guide tube 34. The receiving body 10 is furthermore fixed axially in the guide tube 34 by a securing ring 36.

A securing ring 38 is also provided, for axially securing a guide sleeve 40 that is inserted into the guide tube 34; the hammering bolt 16 is supported axially displaceably in the guide sleeve 40. The guide sleeve 40 is axially fixed here in the guide tube 34 by the securing ring 38 and a further securing ring 42.

Between the guide sleeve 40 and the guide tube 34 of the drill hammer, there is a wave washer 44, which may for instance be made of plastic.

Next to the wave washer 44 is a sealing ring 46, which has both a damping and a sealing function, as will be described in further detail hereinafter.

On the end toward the tool of the guide sleeve 40, there is also a conventional damping bush 48 or intercepting device.

The receiving body 10, on its inside, has a step in which a guide body 50 is disposed; the guide body 50 forms an axial stop toward the tool for the hammering bolt 16 and thus limits the motion of the hammering bolt relative to the tool.

The hammering bolt 16 itself essentially comprises three axially successive portions of different outer diameters. The middle portion of the hammering bolt 16 is guided in the guide sleeve 40, so that the outer diameter of the hammering bolt 16 in the middle portion is essentially equal to the inner diameter of the guide sleeve 40. In the outer jacket face of the hammering bolt 16, in the middle region, there are two sealing rings 52, 54, which axially seal off a gap between the hammering bolt 16 and the guide sleeve 40. The two axially outer portions of the hammering bolt 16 conversely have a substantially smaller outer diameter, so that in these two portions, an annular gap forms between the hammering bolt 16 and the guide sleeve 40.

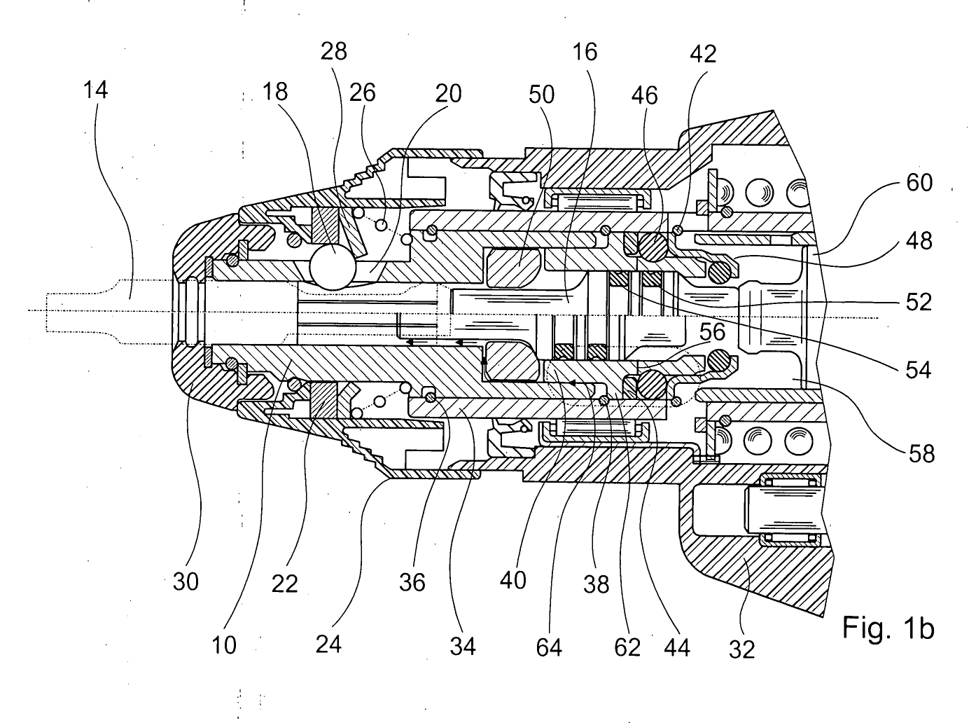

A plurality of radially extending lubricant openings 56 are also disposed in the guide sleeve 40, as can be seen particularly from the detail view in FIG. 2. The lubricant openings 56 serve to deliver lubricant from a lubricant container 58, which is disposed in the gearbox 32.

The mode of operation of the tool receptacle of the invention will now be described, referring to the above description of the structural makeup of the tool receptacle.

In FIGS. 1a and 1b, the hammering bolt 16 is shown above the line of symmetry in a hammering position, in which the hammering bolt 16 experiences axial blows from a hammering body 60 of the drill hammer; with its face end toward the tool, the hammering bolt 16 transmits these blows to the tool shaft 14.

Below the line of symmetry in FIGS. 1a and 1b, the hammering bolt 16 is conversely shown in an idling position, in which the hammering bolt 16, with the flank toward the tool of its middle portion, rests on the guide ring 50; the guide ring 50 forms an axial stop. In the idling position of the hammering bolt 16, the hammering body 60 is received and held by its free end by the damping bush 48, so that the hammering body 60 itself no longer experiences any blows, so that vibration is reduced in the idling position. The hammering bolt 16 accordingly assumes the idling position when the drill hammer is set down from the machined workpiece. The drill hammer is put into position again, the tool shaft 14 then displaces the hammering bolt 16 axially in the direction of the hammering body 60, and the free end of the hammering body 60 is pressed out of the damping bush 48.

In the hammering position of the hammering bolt 16, the sealing ring 54 is located axially ahead of the lubricant openings 56 toward the tool, while the sealing ring 52 is located axially behind the lubricant openings 56 toward the tool, so that the two sealing rings 52, 54 seal off the lubricant openings 56 from the lubricant container 58 in the hammering position of the hammering bolt 16, so that in the hammering position of the hammering bolt 16, no lubrication takes place.

In contrast to this, in the idling position of the hammering bolt 16, both of the sealing rings 52, 54 are axially ahead of the lubricant openings 56 toward the tool, so that lubricant from the lubricant container 58 can pass through the lubricant openings 56 into the interstice between the guide sleeve 40 and the guide tube 54 of the drill hammer. The sealing ring 46 seals off the interstice between the guide sleeve 40 and the guide tube 34 from the tool.

The guide sleeve 40 has an encompassing collar 62, and between the inside of the guide tube 34 and the collar 62, an annular gap remains, through which lubricant can flow axially. In the process, the lubricant moves past an open region of the securing ring 38 in the axial direction.

Along this way, the lubricant reaches the interstice, located axially ahead of the securing ring 38, between the guide sleeve 40 and the guide tube 34 and then flows onward axially between the guide sleeve 40 and the receiving body 10 in the direction of the receiving opening 12.

On emerging from the gap between the guide sleeve 40 and the receiving body 10, the lubricant stream then divides; some of the lubricant flows on the inside past the guide body 50, while another portion of the lubricant flows along the outside of the guide body 50. The two lubricant streams then unite again toward the tool on the front side of the guide body 50 and finally enter the receiving opening 12.

In operation of the drill hammer, compulsory lubrication of the tool shaft 14 and the receiving opening 12 is accordingly effected when the drill hammer is temporarily set down from the machined workpiece, whereupon the hammering bolt 16 assumes the idling position.

An especially advantageous feature here is that no special action by the user is needed, which is important especially for tools intended for home use.

Furthermore, the disposition of the lubricant container 58 in the gearbox 32 makes it possible to hold a large supply of lubricant.

Disposing the lubricant container 58 in the gearbox 32 also enables easy filling of lubricant through a T-handle bore in the gearbox 32.

Finally, the lubricant openings 56 can advantageously be made in the guide sleeve 40 with close production tolerances by laser drilling, and lubricant metering can be done by varying the size, disposition and number of lubricant openings.

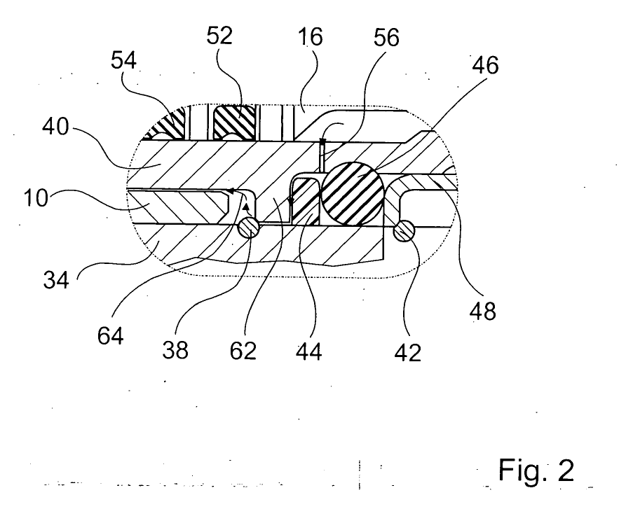

The exemplary embodiment of a tool receptacle shown in FIGS. 3, 4a, 4b and 5 largely agrees with the exemplary embodiment described above, so that to avoid repetition, reference is made to the description above. Also, equivalent components are identified by equivalent reference numerals below, followed by a prime to distinguish them.

A special feature of this exemplary embodiment is that the lubricant delivery into the receiving body 10′ takes place not only whenever the drill hammer is set down from the workpiece and the hammering bolt 16′ assumes the idling position.

Instead, in this exemplary embodiment of a tool receptacle of the invention, lubricant delivery into the receiving opening 12′ also occurs during hammering operation, when the hammering bolt 16′ is in the hammering position.

This is attained in the tool receptacle of the invention by providing that the lubricant metering is done through the guide sleeve 40′, which for this purpose is supported axially displaceably. The displacement of the guide sleeve 40′ is effected by the hammering bolt 16′, which after its hammering motion oriented toward the tool shaft 14′ experiences a contrary impetus from the tool shaft 14′, also known as a B impact. This B impact leads to an axial motion of the hammering bolt 16′ away from the tool shaft 14′, causing the hammering bolt 16′ to strike a shoulder 64 that is integrally formed onto the inside of the guide sleeve 40′, on its side remote from the tool shaft 14′. Upon this impact of the hammering bolt 16′ on the shoulder 64 of the guide sleeve 40′, the guide sleeve 40′ is axially carried with it and in the process moves out of its outset position axially into a lubricating position, in which lubricant is fed into the receiving opening 12′, as will be described in further detail hereinafter.

The axial motion of the guide sleeve 40′ during the B impact is intercepted and in the process damped near the lubricating position by a spring and damping element 66 in the form of a rubber ring. For this purpose, the guide sleeve 40′, on its face end toward the workpiece, has a radially outward-protruding collar 68, on which the spring and damping element 66 rests. On the end axially opposite the collar 68, the spring and damping element 66 rests on a face end of a sintering bearing bush 70, so that upon an axial motion of the guide sleeve 40′ out of the outset position into the lubricating position, the spring and damping element 66 is compressed axially. In addition to damping the axial motion of the guide sleeve 40′ during the B impact, the spring and damping element 66 also has the task of returning the guide sleeve 40′ to the outset position after the B impact. This is done by means of the spring force that the spring and damping element 66, compressed during the B impact, exerts in its compressed state on the collar 68 of the guide sleeve 40′, thus pressing the guide sleeve in the direction of the workpiece.

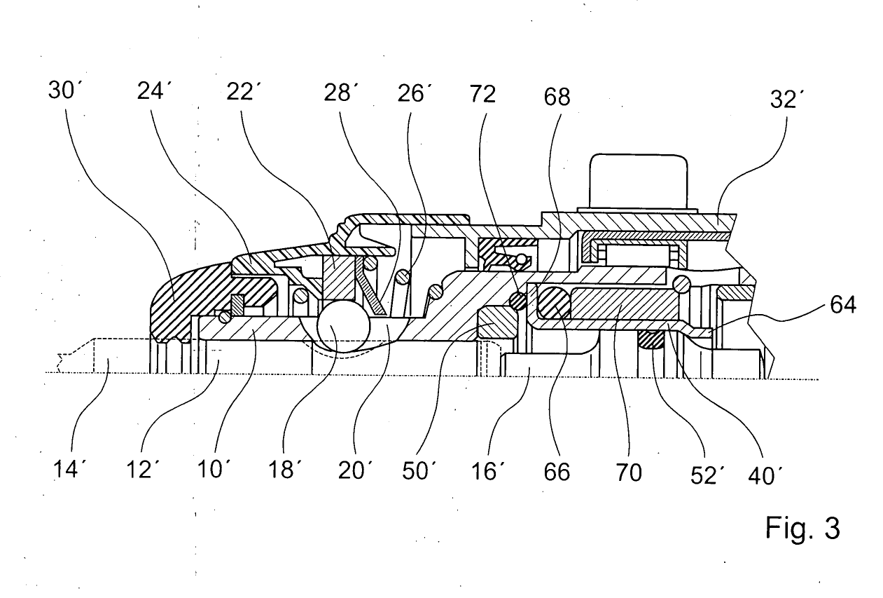

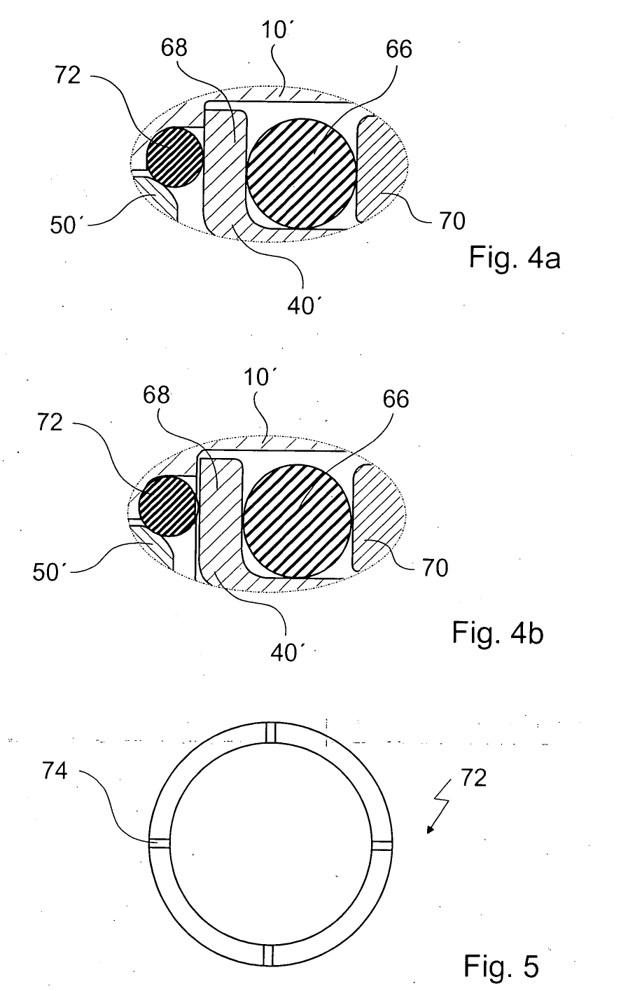

In the outset position of the hammering bolt 16′ as shown in FIG. 4a, the collar 68 of the guide sleeve 40′ rests on an O-ring 72, which is shown in an axial front view in FIG. 5; between the collar 68 of the guide sleeve 40′ and the O-ring 72, there is a substantially circular-annular sealing face, which prevents lubricant from being able to move radially from outside between the O-ring 72 and the collar 68 of the guide sleeve 40′ to penetrate the receiving opening 12′.

In the lubricating position of the guide sleeve 40′ shown in FIG. 4b, conversely, the guide sleeve 40′ is raised slightly axially away from the O-ring 72, thus uncovering a radially extending lubricant opening 74 in the O-ring 72, so that lubricant can pass radially from outside through the lubricant opening 74 in the O-ring 72 inward into the receiving opening 12′. The circular-annular sealing face between the O-ring 72 and the collar 68 of the guide sleeve 40′ is interrupted, in the lubricating position of the guide sleeve 40′, however, only where the lubricant opening 74 is located in the O-ring 72, an opening embodied in this case as a notch in the O-ring 72. In this way, the lubricant delivery 74 is limited in terms of quantity to the cross section of the lubricant opening 74, so that the lubricant delivery can be metered, by using various O-rings 72 with various lubricant openings 74.

It should also be mentioned that the hammering bolt 16′ in this exemplary embodiment has only a single sealing ring 52′, which has the sole function of sealing off the lubricant chamber 58 from the workpiece, while conversely the lubricant metering in this exemplary embodiment is not effected through the sealing ring 52′ of the hammering bolt 16′.

The invention is not limited to the preferred exemplary embodiment described above. On the contrary, many variations and modifications may be made that likewise make use of the concept of the invention and are therefore covered by its scope of patent protection.

List of Reference Numerals

10, 10′ Receiving body
12, 12′ Receiving opening
14, 14′ Tool shaft
16, 16′ Hammering bolt
18, 18′ Ball
20, 20′ Aperture
22, 22′ Closing ring
24, 24′ Actuation sleeve
26, 26′ Spring
28, 28′ Retaining baffle
30, 30′ Dust guard cap
32, 32′ Gearbox
34 Guide tube
36 Securing ring
38 Securing ring
40, 40′ Guide sleeve
42 Securing ring
44 Wave washer
46 Sealing ring
48 Damping bush
50, 50′ Guide body
52, 52′ Sealing ring
54 Sealing ring
56, 56′ Lubricant opening
58, 58′ Lubricant chamber
60, 60′ Hammering body
62 Collar of the guide sleeve
64 Shoulder of the guide sleeve
66 Spring and damping element
68 Collar of the guide sleeve
70 Sintering bearing bush
72 O-ring
74 Lubricant opening

1. A tool receptacle for a hand power tool, in particular for a drill hammer and/or jackhammer, having a receiving opening (12, 12′) for receiving a tool shaft (14, 14′) and having a hammering bolt (16, 16′), wherein the tool shaft (14, 14′) and/or the hammering bolt (16, 16′) has an ready position located between an idling position and a hammering position, and having a lubricant opening (56, 74) for delivering lubricant, which lubricant opening is fixed relative to the hammering bolt (16, 16′), and having a lubricant valve (16, 56, 68, 72) with a variable valve position for metering lubricant, characterized in that the valve position of the lubricant valve (16, 56, 68, 72) is dependent on the ready position of the hammering bolt (16, 16′) and/or of the tool shaft (14, 14′) between the idling position and the hammering position.

2. The tool receptacle of claim 1, characterized in that the lubricant valve (16, 56) is open in the idling position of the hammering bolt (16) and is closed in the hammering position of the hammering bolt (16).

3. The tool receptacle of claim 1, characterized in that the hammering bolt (16) is displaceable in a guide sleeve (40), and the lubricant opening (56) is disposed in the guide sleeve (40).

4. The tool receptacle of claim 3, characterized in that the hammering bolt (16) has three portions located in axial succession, and the middle portion of the hammering bolt (16) has an outer diameter which is essentially equal to the inner diameter of the guide sleeve (40), while the outer diameter of the two outer portions of the hammering bolt (16) is less than inner diameter of the guide sleeve (40).

5. The tool receptacle of claim 3, characterized in that the lubricant opening (56) changes over on the outside of the guide sleeve (40) to a first lubricant conduit, which discharges into the receiving opening (12, 12′).

6. The tool receptacle of claim 5, characterized in that the first lubricant conduit discharges substantially axially into the receiving opening (12).

7. The tool receptacle of claim 3, characterized in that the guide sleeve (40) changes over on the inside into a second lubricant conduit, which discharges into a lubricant chamber (58).

8. The tool receptacle of claim 1, characterized in that a gearbox (32) is provided, and the lubricant chamber (58) is integrated with the gearbox (32).

9. The tool receptacle of claim 3, characterized in that the hammering bolt (16), on its jacket face, has at least one sealing element, in order to seal off a gap between the hammering bolt (16) and the guide sleeve (40).

10. The tool receptacle of claim 9, characterized in that the hammering bolt (16), on its jacket face, has at least two sealing elements (52, 54), which are axially spaced apart from one another, and the lubricant opening (56) in the guide sleeve (40) is located axially between the two sealing elements (52, 54), in a ready position of the hammering bolt (16).

11. The tool receptacle of claim 1, characterized in that a guide sleeve (40′) is axially displaceable by the hammering bolt (16′), and the valve position of the lubricant valve (72, 68) is dependent on the axial position of the guide sleeve (40′).

12. The tool receptacle of claim 11, characterized in that for axially restoring the guide sleeve (40′) to an outset position, a spring and/or damping element (66) is provided.

13. A hand power tool having a tool receptacle of claim 1.
